(19) United States
(12) Patent Application Publication
(10) Pub. No.: US 2023/0197928 A1
(43) Pub. Date: Jun. 22, 2023

(54) BATTERY ELECTRODE

(71) Applicant: GM GLOBAL TECHNOLOGY OPERATIONS LLC, Detroit, MI (US)

(72) Inventor: Seung-Woo Chu, Clawson, MI (US)

(73) Assignee: GM GLOBAL TECHNOLOGY OPERATIONS LLC, Detroit, MI (US)

(21) Appl. No.: 17/559,093

(22) Filed: Dec. 22, 2021

(51) Int. Cl. H01M 4/136; H01M 4/58; H01M 4/62; H01M 4/66; H01M 10/0525; H01M 4/04

(52) U.S. Cl. CPC H01M 4/136; H01M 4/58; H01M 4/622; H01M 4/625; H01M 4/661; H01M 10/0525; H01M 4/0404; H01M 4/0409; H01M 4/0411; H01M 4/0435; H01M 2004/027

(57) ABSTRACT

The concepts herein provide for a rechargeable lithium-ion battery cell having an anode with improved properties, including a capability to suppress formation of lithium dendrites after cell formation and in-use. This includes an anode for a rechargeable battery that includes a current collector having an indium nitride layer, wherein the indium nitride layer includes indium nitride, an electrically conductive material, and a polymeric binder.

### INTRODUCTION

Lithium ion battery packs may include one or multiple lithium ion battery cells that are electrically connected in parallel or in series, depending upon the needs of the system. Each battery cell includes one or a plurality of lithium ion electrode pairs that are enclosed within a sealed pouch envelope, a metallic prismatic can, or a cylindrical metallic can. In some embodiments, each electrode pair includes a negative electrode (anode) and a positive electrode (cathode), with a separator arranged therebetween. The separator functions to physically separate and electrically isolate the negative and positive electrodes, while permitting lithium ion transfer.

To facilitate lithium ion mobility, an electrolytic material that contains lithium ions may be present within the separator. The electrolytic material allows lithium ions to pass through the separator between the positive and anodes to counterbalance the flow of electrons that, during charge and discharge cycles of the lithium ion battery cell, circumvent the separator and move between the electrodes through an external circuit. Depending on their chemistry, each lithium ion battery cell has a maximum or charging voltage (voltage at full charge) due to the difference in electrochemical potentials of the electrodes. For example, each lithium ion battery cell may have a charging voltage in the range of 3V to 5V and a nominal open circuit voltage in the range of 2.9V to 4.2V.

Each battery cell is configured to electrochemically store and release electric power. Each anode has a current collector in the form of a negative foil that is coupled to a negative terminal tab, and each positive electrode has a current collector with a positive foil that is coupled to a positive terminal tab. Lithium-ion battery cells are capable of being discharged and re-charged over many cycles.

There are benefits to having an improved anode in a battery cell, and an improved process for forming an anode.

### SUMMARY

The concepts herein provide for a rechargeable lithium-ion battery cell having an anode with improved properties, including a capability to suppress formation of lithium dendrites after cell formation and in-use.

An aspect of the disclosure includes an anode for a rechargeable battery that includes a current collector having an indium nitride layer, wherein the indium nitride layer includes indium nitride, an electrically conductive material, and a polymeric binder.

Another aspect of the disclosure includes the metallic substrate being fabricated from copper or a copper alloy, stainless steel or nickel.

Another aspect of the disclosure includes the metallic substrate being fabricated from a material that does not alloy with lithium.

Another aspect of the disclosure includes the indium nitride layer having a maximum of 50% (wt.) of indium nitride.

Another aspect of the disclosure includes the indium nitride layer having a maximum of 10% (wt.) of a polymeric binder.

Another aspect of the disclosure includes the electrically conductive material being at least one of carbon black, graphite, graphene, or carbon nanotubes (CNT).

Another aspect of the disclosure includes the indium nitride layer having a thickness that is between 4 microns and 12 microns.

Another aspect of the disclosure includes the indium nitride layer having a thickness that is between 1 micron and 5 microns.

Another aspect of the disclosure includes the indium nitride transforming to lithium nitride and a lithium-indium alloy composite in the presence of lithium.

Another aspect of the disclosure includes a battery cell that includes an anode, a separator, and a cathode, wherein the anode includes a current collector having an indium nitride layer. The indium nitride layer includes indium nitride, an electrically conductive material, and a polymeric binder.

Another aspect of the disclosure includes a method for forming an anode for a battery cell that includes forming an indium nitride slurry that includes indium nitride, an electrically conductive material, and a polymeric binder, applying the indium nitride slurry as a layer to a metallic substrate, and curing the layer to bind the layer onto the metallic substrate.

Another aspect of the disclosure includes applying the slurry via a slot die coating process to form the layer.

Another aspect of the disclosure includes employing a gravure coating process to form the layer.

Another aspect of the disclosure includes the polymeric binder having an ultraviolet (UV)-curable polymer, and curing the layer to bind the layer onto the metallic substrate by exposing the layer to ultraviolet light.

Another aspect of the disclosure includes calendering the layer on the metallic substrate after curing.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically shows an exploded isometric view of a prismatic battery cell that includes an anode, an electrolytic material, a separator, and a cathode, in accordance with the disclosure.

FIG. 2 schematically illustrates a cutaway side view of an embodiment of an anode that includes an anode current collector with an indium nitride layer, in accordance with the disclosure.

FIG. 3 schematically illustrates a cutaway side view of an embodiment of an anode that includes an anode current collector with an indium nitride layer during formation of the battery cell, in accordance with the disclosure.

FIG. 4 schematically illustrates a cutaway side view of an embodiment of an anode that includes an anode current collector with an indium nitride layer after charging, in accordance with the disclosure.

FIG. 5 schematically illustrates elements of a process for forming an anode for a battery cell, in accordance with the disclosure.

The appended drawings are not necessarily to scale, and present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description to provide a thorough understanding of the embodiments disclosed herein, some embodiments can be practiced without some of these details. Moreover, for the purpose of clarity, certain technical material that is understood in the related art has not been described in detail to avoid unnecessarily obscuring the disclosure. Furthermore, the drawings are in simplified form and are not to precise scale. For purposes of convenience and clarity only, directional terms such as top, bottom, left, right, up, over, above, below, beneath, rear, and front, may be employed to assist in describing the drawings. These and similar directional terms are illustrative, and are not to be construed to limit the scope of the disclosure. Furthermore, the disclosure, as illustrated and described herein, may be practiced in the absence of an element that is not specifically disclosed herein.

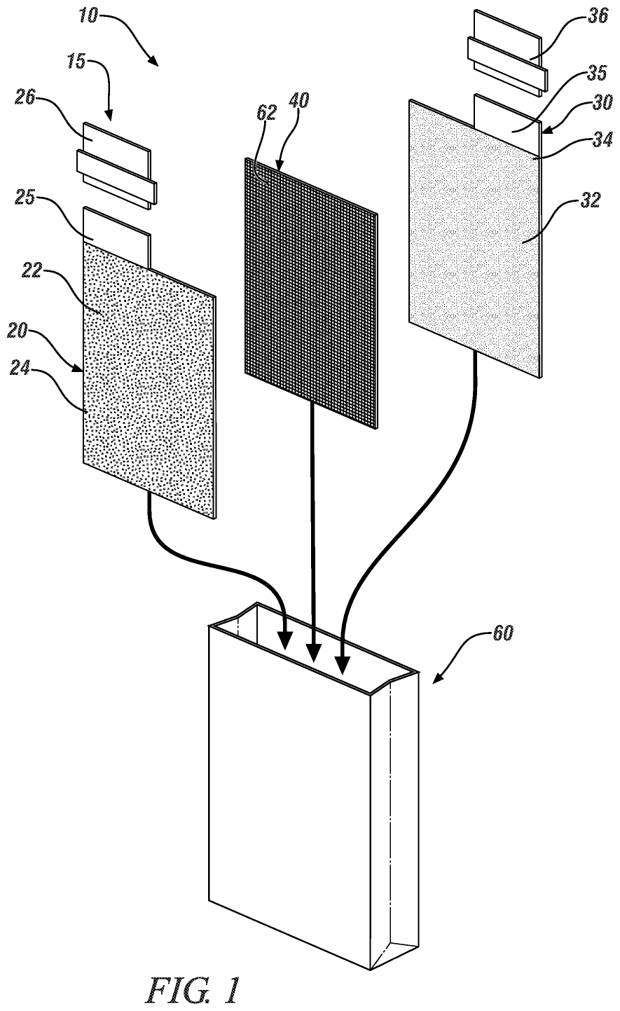

Referring to the drawings, wherein like reference numerals correspond to like or similar components throughout the several Figures, FIG. 1 schematically illustrates an embodiment of a prismatically-shaped lithium ion battery cell 10 that includes an electrode pair 15 having an anode 20, a separator 40, and a cathode 30 that are arranged in a stack and sealed in a flexible pouch 60 containing an electrolytic material 62. In one embodiment of the battery cell, a reference electrode may be arranged between the anode and the cathode. A first, negative battery cell tab 26 and a second, positive battery cell tab 36 protrude from the flexible pouch 60. The terms “anode” and “negative electrode” are used interchangeably. The terms “cathode” and “positive electrode” are used interchangeably. A single electrode pair 15 including an arrangement of the anode 20, separator 40, and cathode 30 is illustrated. It is appreciated that multiple electrode pairs 15 may be arranged and electrically connected in the flexible pouch 60, depending upon the specific application of the battery cell 10.

The anode 20 includes a first active material 22 that is arranged on an anode current collector 24. The anode current collector 24 is a metallic substrate with a foil portion 25 that extends from the first active material 22 to form the first battery cell tab 26.

The cathode 30 includes a second active material 32 that is arranged on a cathode current collector 34, with the cathode current collector 34 having a foil portion 35 that extends from the second active material 32 to form the second battery cell tab 36.

The anode and cathode current collectors 24, 34 are thin metallic plate-shaped elements that contact their respective first and second active materials 22, 32 over an appreciable interfacial surface area. The purpose of the anode and cathode current collectors 24, 34 is to exchange free electrons with their respective first and second active materials 22, 32 during discharging and charging.

The anode current collector 24 is a flat, plate-shaped metallic substrate in the form of a rectangular planar sheet in one embodiment, although in some embodiments it may be arranged as a planar sheet having a non-rectangular shape, a coiled configuration, a cylindrical configuration, or another configuration.

The anode current collector 24 is fabricated from one of copper, copper alloy, stainless steel, nickel, etc., or another material that does not alloy with lithium. In one embodiment, the anode current collector 24 has a thickness at or near 0.02 mm. The first active material 22 is an indium nitride layer 23 that is applied onto one or both surfaces of the anode current collector 24.

The cathode current collector 34 is a metallic substrate in the form of a planar sheet that is fabricated from aluminum or an aluminum alloy, and has a thickness at or near 0.02 mm in one embodiment. The separator 40 is arranged between the anode 20 and the cathode 30 to physically separate and electrically isolate the anode 20 from the cathode 30.

The electrolytic material 62 that conducts lithium ions is contained within the separator 40 and is exposed to each of the anode 20 and the cathode 30 to permit lithium ions to move between the anode 20 and the cathode 30. Lithium ions are stripped from the anode 20 during discharge, or from the cathode 30 during charge give up electrons that flow through the current collectors 24 and 34, respectively, through an external circuit connected either to a load or a charger, and then to the opposite current collectors (34 and 24) and electrodes (30 and 20) where they reduce lithium ions as they are being intercalated.

The anode 20 and the cathode 30 are each fabricated as electrode materials that are able to deposit and strip the lithium ions (on an anode), or intercalate and de-intercalate (on a cathode). The electrode materials of the anode 20 and the cathode 30 are formulated to store lithium at different electrochemical potentials relative to a common reference electrode, e.g., lithium. In the construct of the electrode pair 15, the anode 20 stores deposited or plated lithium at a lower electrochemical potential (i.e., a higher energy state) than the cathode 30 such that an electrochemical potential difference exists between the anode 20 and the cathode 30 when the anode 20 is lithiated. The electrochemical potential difference for each battery cell 10 results in a charging voltage in the range of 3V to 5V and nominal open circuit voltage in the range of 2.9V to 4.2V. These attributes of the anode 20 and the cathode 30 permit the reversible transfer of lithium ions between the anode 20 and the cathode 30 either spontaneously (discharge phase) or through the application of an external voltage (charge phase) during operational cycling. The thickness of the anode 20 ranges between 10 microns (um) and 20 um in one embodiment.

The indium nitride layer 23 of the anode 20 includes indium nitride 27, an electrically conductive material 28, and a polymeric binder 29. The indium nitride 27 functions as a protective layer of highly reactive lithium metal anode when transformed as a composite of lithium nitride (Li3N) and a lithium-indium alloy (LixIny) during the cell formation process. The electrically conductive material 28 may be, for example, carbon black, graphite, graphene, CNT, or another type of carbon material. The carbon black includes a conductive type of carbon, which combines a high specific surface and an extensively develop structure that enhances microporosity. The electrically conductive material 28 is intermingled with a polymeric binder 29 to provide the anode 20 with structural integrity. The carbon and polymer composite function as electrically conductive and stress relaxing components in the indium nitride layer. The polymeric binder 29 is preferably one or more of polyvinylidene fluoride (PVdF), a polyacrylic acid polymer, PTFE, styrene butadiene rubber (SBR), a carboxymethyl cellulose (CMC), or mixtures thereof. Graphite, graphene, CNT, carbon black, or another type of carbon material is advantageously used to make the anode 20 because, in addition to being relatively inert, its layered or fibrous structure exhibits favorable characteristics that help dissipate the stress generated during the lithium plating or depositing. Various types of carbon material that may be used to construct the anode 20 are commercially available.

The second active material 32 of the cathode 30 is composed as a lithium-based active material that stores intercalated lithium at a higher electrochemical potential (relative to a common reference electrode) than the electrically conductive material used to make the anode 20. The same polymeric binders (PVdF, PTFE, polyacrylic acid) and conductive fine particle diluent (high-surface area carbon black) that may be used to construct the anode 20 may also be intermingled with the lithium-based active material of the cathode 30 for the same purposes. The lithium-based active material is preferably a layered lithium transition metal oxide, such as lithium cobalt oxide, lithium nickel cobalt manganese oxide, a spinel lithium transition metal oxide, such as lithium manganese oxide, lithium nickel manganese oxide, an olivine-type cathode material, such as lithium iron phosphate, or lithium iron manganese phosphate. Some other suitable lithium-based active materials that may be employed as the lithium-based active material include lithium nickel oxide, lithium aluminum manganese oxide, and lithium vanadium oxide, to name examples of alternatives. Mixtures that include one or more of these recited lithium-based active materials may also be used to make the cathode 30.

The separator 40 may be composed as a porous ceramic coating layer or a porous polymer layers that, individually, may be composed of any of a wide variety of polymers that provide thermal stability. Only one such polymer layer is shown here for simplicity. Each of the one or more polymer layers may be a polyolefin. Some specific examples of a polyolefin are polyethylene (PE) (along with variations such as HDPE, LDPE, LLDPE, and UHMWPE), polypropylene (PP), or a blend of PE and PP. The polymer layer(s) function to electrically insulate and physically separate the anode 20 and the cathode 30. The first separator 40 may further be infiltrated with a liquid electrolytic material throughout the porosity of the polymer layer(s). The liquid electrolytic material, which also wets both the anode 20 and the cathode 30, preferably includes a lithium salt dissolved in a non-aqueous solvent. The separator 40 has a thickness that may be between 10 microns (um) to 50 um.

The descriptions set forth above pertaining to the anode 20, the cathode 30, the separator 40, and the electrolytic material 62 are intended to be non-limiting examples. Many variations on the chemistry of each of these elements may be applied in the context of the lithium ion battery cell 10 of the present disclosure. For example, the electrically conductive material of the anode 20 and lithium-based active material of the cathode 30 may be compositions other than those specific electrode materials listed above, particularly as lithium ion battery electrode materials continue to be researched and developed. Additionally, the polymer layer(s) and/or the electrolytic material contained within the polymer layer(s) of the separator 40 may also include other polymers and electrolytic materials than those specifically listed above. In one variation, the separator 40 may be a solid polymer electrolytic material that includes a polymer layer—such as polyethylene oxide (PEO), polypropylene oxide (PPO), polyacrylonitrile (PAN), a solid electrolytic material, e.g., an oxide-based electrolytic material or a sulfide-based electrolytic material, or a gel polymer electrolytic material having a lithium salt or swollen with a lithium salt solution. The anode 20 and cathode 30 reversibly exchange lithium ions through the separator 40 during applicable discharge and charge cycles.

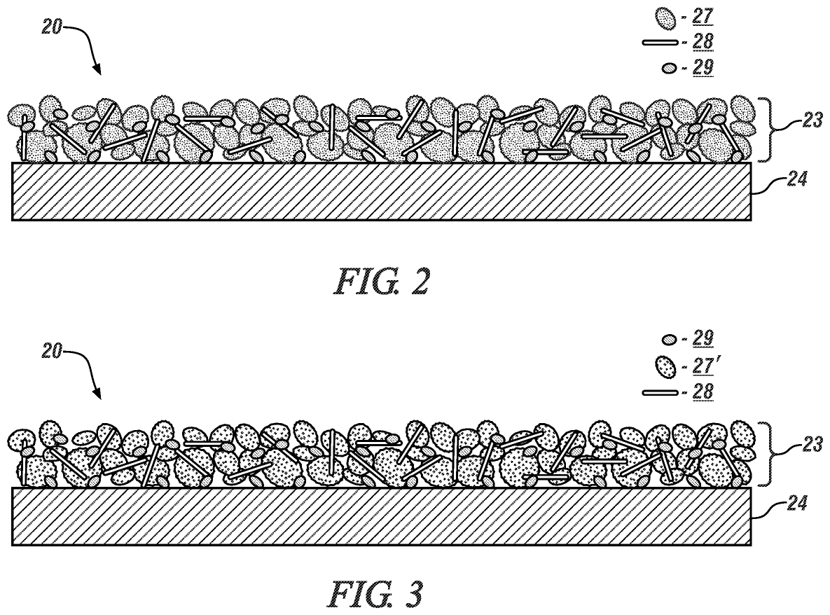

FIG. 2 schematically illustrates an embodiment of the anode 20, which includes the anode current collector 24 having an indium nitride layer 23 thereon, after drying the indium nitride slurry. In one embodiment and as shown, the indium nitride layer 23 is applied onto one side of the anode current collector 24. Alternatively, the indium nitride layer 23 may be applied onto both sides of the anode current collector 24. The indium nitride layer 23 contains 4%-45% wt. of indium nitride 27, 50%-90% wt. of the electrically conductive material 28, and 1%-10% of the polymeric binder. In one embodiment, the indium nitride layer 23 includes a maximum of 50% (wt.) of indium nitride 27, and a maximum of 10% (wt.) of the polymeric binder 29.

The indium nitride slurry includes a mixture of indium nitride 27, electrically conductive material 28, the polymeric binder 29 and a solvent (not shown).

The indium nitride has a maximum particle size of 10 microns and minimum particle size of 100 nm, with a purity minimum of 99.0%.

The electrically conductive material 28 may be composed of one of or a mixture of carbon black, graphite, graphene, carbon nanotube (CNT), or another carbon material.

The polymeric binder 29 serves as a binding material to join the electrically conductive material 28, the indium nitride 27, and the collector 24. The polymeric binder 29 may be composed of polyvinyl alcohol, polyvinyl butyral, PVdF, polyvinyl acetate and vinyl acetate copolymers and terpolymers, cellulosic polymers and acrylics, polyvinyl acetate and vinyl acetate copolymers and terpolymers, etc., and may be in the form of a powder, a resin, or dissolved in the solvent. In one embodiment, the polymeric binder 29 is curable using ultra-violet (UV) light. In this embodiment, the indium nitride slurry is formed or prepared using a UV-curable polymer. This avoids exposing the indium nitride slurry to elevated temperatures, which facilitates faster manufacturing times and lower manufacturing costs.

The mixture of indium nitride 27, electrically conductive material 28, and polymeric binder 29 that forms the indium nitride layer 23 is formed into the indium nitride slurry employing an organic solvent or water by mixing, as illustrated by Step S501 of process 500 of FIG. 5. In one embodiment, the organic solvent is N-methyl-2-pyrrolidone (NMP).

The indium nitride slurry containing the indium nitride layer 23 may be applied onto the anode current collector 24, as illustrated by Step S502 of process 500 of FIG. 5.

The indium nitride layer 23 may be applied onto the anode current collector 24 by gravure coating, slot die coating, or dip coating in one embodiment. Slot-die coating is a deposition technique in which the indium nitride slurry is delivered onto the substrate of the anode current collector 24 via a narrow slot positioned close to the surface. A major advantage of the slot-die coating method is the simple relationship between wet-film coating thickness, the flow rate of solution, and the speed of the coated substrate relative to the head. In addition, slot-die coating is capable of achieving extremely uniform films across large areas. Slot-die coating is one of many methods that can be used to deposit a thin liquid film onto the surface of a substrate. One of the main advantages of slot-die coating is that it can easily be integrated into scale-up processes including roll-to-roll coating and sheet-to-sheet deposition systems.

The indium nitride slurry containing the indium nitride layer 23 may be applied onto the anode current collector 24 by dipping the current collector 24 into a bath containing the indium nitride slurry in one embodiment.

The anode current collector 24 having the indium nitride layer 23 applied thereon is subjected to a drying process to bind the indium nitride layer 23 onto the surface of the anode current collector 24 to form the anode 20, as illustrated by Step S503 of process 500 of FIG. 5. The drying process may include subjecting the anode current collector 24 with the applied indium nitride layer 23 to an elevated temperature environment for a period of time to remove the solvent. In one embodiment, this may include subjecting the anode current collector 24 with the applied indium nitride layer 23 to a calendering process to improve adhesion of the indium nitride layer 23 onto the surface of the anode current collector 24. The anode current collector 24 with the applied indium nitride layer 23 is subjected to a temperature between 60° C. and 150° C. for a period of 1 to 60 minutes to dry and remove the solvent after binding the indium nitride layer 23 onto the surface of the anode current collector 24. Alternatively, the polymeric binder 29 may include an ultraviolet (UV)-curable polymer. In this embodiment, the indium nitride layer 23 is cured to bind the layer onto the metallic substrate by exposure to UV light.

In one embodiment, the indium nitride layer 23 has a thickness that is a range between 4 microns and 12 microns.

In one embodiment, the indium nitride layer 23 has a thickness that is a range between 1 micron and 5 microns.

FIG. 3 schematically illustrates an embodiment of the anode 20 after having been assembled into an embodiment of the battery cell 10 described with reference to FIG. 1 after activation. The anode current collector 24 has the indium nitride layer 23 with electrically conductive material 28 and polymeric binder 29. The indium nitride 27 has transformed, in the presence of lithium, to lithium nitride (Li3N) and a lithium-indium alloy (LixIny) composite.

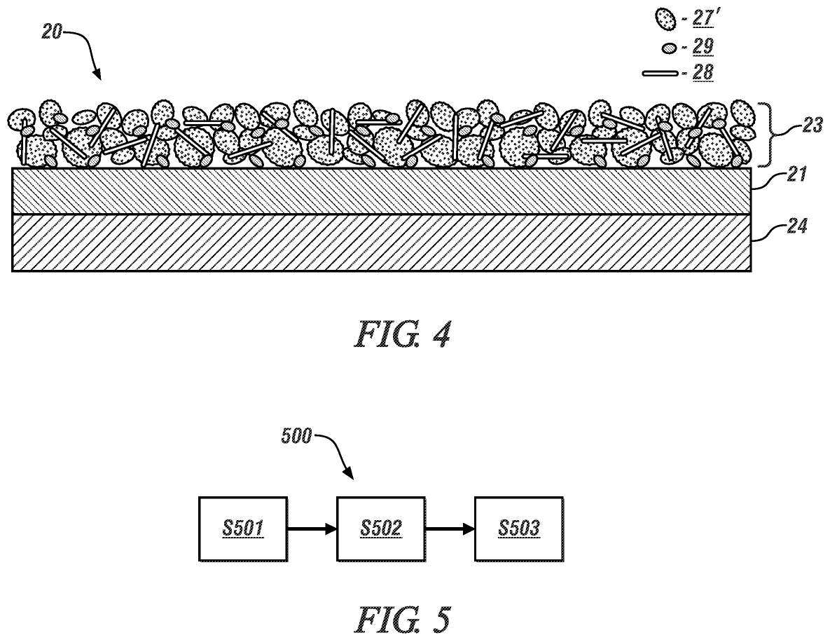

FIG. 4 schematically illustrates an embodiment of the anode 20 after having been assembled into an embodiment of the battery cell 10 described with reference to FIG. 1, after activation and full charging. The anode current collector 24 has the indium nitride layer 23 with electrically conductive material 28 and polymeric binder 29. The indium nitride 27 reacts, in the presence of lithium ions (Li+), to form a composite of lithium nitride (Li3N) and lithium-indium alloy (LixIny) 27′. A lithium deposit 21 is formed on the anode current collector 24 by the charging event.

The indium nitride layer 23 is applied as a slurry using a gravure coating method, a slot-die coating method, a dip coating method, or another slurry application process to form anode 20. This avoids issues that would otherwise be introduced by applying indium onto an anode current collector employing a sputtering or related process.

The indium nitride (InN) layer provides a mechanism to suppress lithium dendrite formation. This is due to the electrically conductive materials and polymeric binder material that function as stress relaxation elements. The activated InN forms a Li-ion conducting surface layer that has limited direct contact of highly reactive lithium with the electrolytic material.

As used herein, “thin” in certain embodiments refers to a thickness of less than about 100-200 microns, and “ultrathin” refers to a thickness that is less than 50 microns and as thin as 5 microns.

This concept enables the large-scale mass manufacturing of battery cells having electrodes by enabling part-to-part consistency, reducing material cost and reducing manufacturing complexity.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. An anode for a rechargeable battery, comprising:
a current collector including a metallic substrate having an indium nitride layer;
wherein the indium nitride layer includes indium nitride, an electrically conductive material, and a polymeric binder.

2. The anode of claim 1, wherein the metallic substrate is fabricated from copper, a copper alloy, stainless steel, or nickel.

3. The anode of claim 1, wherein the metallic substrate is fabricated from a material that does not alloy with lithium.

4. The anode of claim 1, wherein the indium nitride layer includes a maximum of 50% (wt.) of indium nitride.

5. The anode of claim 1, wherein the indium nitride layer includes a maximum of 10% (wt.) of a polymeric binder.

6. The anode of claim 1, wherein the electrically conductive material comprises at least one of carbon black, graphite, graphene, or carbon nanotubes (CNT).

7. The anode of claim 1, wherein the indium nitride layer has a thickness that is between 4 microns and 12 microns.

8. The anode of claim 1, wherein the indium nitride layer has a thickness that is between 1 micron and 5 microns.

9. The anode of claim 1, wherein the indium nitride transforms to lithium nitride and a lithium-indium alloy composite in the presence of lithium.

10. A battery cell, comprising:
an anode, a separator, and a cathode;
wherein the anode includes a metallic substrate having an indium nitride layer; and
wherein the indium nitride layer includes indium nitride, an electrically conductive material, and a polymeric binder.

11. The battery cell of claim 10, wherein the indium nitride transforms to lithium nitride and a lithium-indium alloy composite in the presence of lithium.

12. The battery cell of claim 10, wherein the indium nitride layer includes a minimum of 50% (wt.) of indium nitride.

13. The battery cell of claim 10, wherein the indium nitride layer includes a maximum of 5% (wt.) of a polymeric binder.

14. The battery cell of claim 10, wherein the electrically conductive material of the indium nitride layer comprises one of graphite, graphene, or carbon nanotubes (CNT).

15. The battery cell of claim 10, wherein the indium nitride layer has a thickness that is within a range between 4 microns and 12 microns.

16. A method for forming an anode for a battery cell, comprising:
forming a slurry including indium nitride, an electrically conductive material, and
a polymeric binder;
applying the slurry as a layer to a metallic substrate; and
curing the layer to bind the layer onto the metallic substrate.

17. The method of claim 16, wherein applying the slurry as the layer to the metallic substrate comprises applying the slurry via a slot die coating process to form the layer.

18. The method of claim 16, wherein applying the slurry as the layer to the metallic substrate comprises employing a gravure coating process to form the layer.

19. The method of claim 16, wherein the polymeric binder includes an ultraviolet (UV)-curable polymer; and wherein curing the layer to bind the layer onto the metallic substrate comprises exposing the layer to ultraviolet light.

20. The method of claim 16, further comprising calendering the layer on the metallic substrate after the curing.
